(19) United States
(12) Patent Application Publication
(10) Pub. No.: US 2009/0276091 A1
(43) Pub. Date: Nov. 5, 2009

(54) APPARATUS FOR USE IN DISPENSING TINTED PAINT

(76) Inventors: Emeric John Duha, Winnipeg (CA); Jason Udo Franz Fuith, Winnipeg (CA); Dean Michael Weiten, Headingley (CA)

Correspondence Address: ADE & COMPANY INC., 2157 Henderson Highway, WINNIPEG, MB, R2G1P9, CA

(21) Appl. No.: 12/112,161

(22) Filed: Apr. 30, 2008

(51) Int. Cl. B01F 15/04; G06F 17/00; B01F 13/00; B65B 1/30

(52) U.S. Cl. 700/239; 141/104; 222/52; 700/225

(57) ABSTRACT

Readable tags on paint chips and on paint cans are used to manage the dispensing of tinted paint to customers so that the paint chips can be monitored to control the recipes and the inventory of chips and the paint cans can be detected to ensure the use of authenticated paint. The tags are preferably contact readable by printed conductors on the chips and on the cans. Further tags can be used to input further paint characteristics. The tinting machine can also store in memory the tint recipe used in a particular can so that it can be later reproduced in a second can. An over-ride switch is provided in the case the system fails and if the customer wants a particular recipe, in which case the recipe actually dispensed is stored in memory. Analysis of the can codes is carried out to prevent counterfeiting of the cans is carried out either in real time or subsequently.

This invention relates to an apparatus for use in dispensing tinted paint.

### BACKGROUND OF THE INVENTION

Tinted paint is sold in stores by mixing colorants with a can of a base paint typically using a dispensing machine which supplies measured quantities of the colorants according to a recipe.

The customer selects a required color typically using so-called paint chips where the colors available are supplied as variously sized samples on paper or other substrate which can be taken from a store for the customer to use at their home in determining the shade or color required.

Considerable development and expenditure is undertaken by paint suppliers in developing new shades to follow current fashion trends and therefore to develop these paint chips. This cost is recovered only in the profit obtained from selling the can of base paint to the customer for mixing in the dispensing machine.

At present there is no system available for automatically monitoring the supply of the paint chips or for automatically monitoring whether the paint used in the mixing process is that of the supplier of the paint chip, since substitute brands or counterfeit paint can be used by a retailer or customer without difficulty.

Further the paint supplier has no information as to which shades are being selected for each individual can of paint since the dispensing machine has no means of recording and correlating each can of paint and shades mixed therein and since the colorants themselves are standard stock and total colorant usage provides no information as to each individual dispensation thereof.

U.S. Pat. No. 6,701,977 (Taylor) issued Mar. 9, 2004 of ICI relates in general to a method of mixing paints in the dispensing machine and provides information as to the methods of controlling the amounts of colorant supplied. This provides information giving details of a type of mixing machine which may be used in the present invention and the disclosure of this patent is incorporated herein by reference.

U.S. Pat. No. 7,206,664 (Schmid) issued Apr. 17, 2007 to Mettler Toledo AG relates to a method for mixing paints and particularly of getting color data or recipes from a remote site using a communications module. This provides information giving details of a type of mixing machine which may be used in the present invention and the disclosure of this patent is incorporated herein by reference.

### SUMMARY OF THE INVENTION

It is one object of the invention to provide an improved apparatus for dispensing tinted paint.

According to one aspect of the invention there is provided an apparatus for use in dispensing tinted paint comprising:

a plurality of sets of paint chips, each comprising a substrate and having applied thereto at least one paint sample of a selected shade;

a paint chip display stand having a plurality of receptacles each for receiving a selected one of the sets so that the sets can be displayed to a potential purchaser for selection by the purchaser of a selected one of the paint chips carrying a desired paint shade;

each paint chip having applied thereto a component defining a readable code;

a plurality of cans of paint base;

each can of paint base having thereon a component defining a readable code;

a paint tinting station;

the paint tinting station having a location for receiving a selected one of the cans of paint base;

the paint tinting station having a reader for reading the code on the selected one of the cans of paint base;

the paint tinting station having a reader for reading the code on the selected one of the paint chips;

the paint tinting station having a dispenser of colorants for mixing with the paint base in the selected can to formulate a required shade;

the paint tinting station having a processor for controlling the dispenser in accordance with a pre-determined recipe for the required shade, the processor being arranged to receive data from the codes on the paint chips when read and the codes on the cans when read;

the processor being arranged to obtain the recipe using the data received;

the processor being arranged to operate the dispenser to dispense into a selected can a recipe of colorants after reading the code on the paint chip, after determining the pre-determined recipe and after reading the code on the can.

The recipe can be stored on the chip as part of the code but more preferably it is retained on a memory at the dispensing system or at a remote location where it can be accessed. The recipe may be adjusted for volume of paint base or type of paint.

The authenticity of the can code can be used to prevent dispensing into unauthorized cans or it can be used as information for later determination of brand substitution or counterfeiting.

The component on the paint chip is an electronic device readable by RF transmission or an electronic device with conductors on the chip readable by contact with a conductive sensor. However other ID tags can be used for example a barcode.

The conductors can be formed from a conductive ink in which case the ink may include a part of the ink located on the edge of the substrate and a part of the ink located on the face of the substrate.

Preferably there is provided a device at or on the paint chip display stand for reading the components on the paint chips and this can be used to provide an indication of the number of paint chips remaining at the paint chip display stand for re-stocking and inventory control.

The device at the paint chip display stand can read the tag by remote RF reading where the tag is an RFID or other wireless RF technology or can be arranged for contacting a conductor on an edge of the paint chips. In this case the component on the paint chip can be an RFID and the edge conductor communicates with the RFID though conductive traces such as a conductive ink rather than by wireless RF.

In this case the device at the paint chip display stand can include a power bus for providing power to the components on the paint chips and a read/write bus for communicating with the components on the paint chips, the two busses may be shared as the same physical bus.

As an alternative to counting the number of chips by reading the tags, the device at the paint chip display stand can be arranged to determine the number of paint chips by measuring a thickness of a stack of the paint chips.

In some cases, at least some of the paint chips have thereon multiple colors, where each paint chip is associated with one readable code or RFID tag.

The paint tinting station may include a display for showing to a customer a sample of the color selected and particularly for showing to a customer a sample of the color selected where at least some of the paint chips have thereon multiple colors so that the customer can select a displayed color at the display.

Preferably the paint tinting station includes a connection for electronic communication with a remote station including a remote smart cache of recipes for retrieving other recipes not stored in the memory so that the dispensing device may contain in the memory recipes of color chips contained in paint chip display stands at the same location or store and may use the remote cache for others which are not recognized in the memory.

Preferably the paint tinting station includes in the memory a list of authentic cans for determining from the code read from the can an authentication of the can and the processor is arranged to delete a can from the list when used for dispensing so that the same can cannot be refilled with other paint and re-used nor may the code be removed from the can so as to be applied to falsely authenticate without an authentic can present.

Preferably the component on the cans is an RFID and the reader is an RFID reader but other types of tags can be used.

Preferably the memory and the processor of the paint tinting station are arranged to keep the recipes secret so that dispensing is carried out automatically without providing information to the customer or a store clerk.

Preferably the memory and the processor of the paint tinting station are arranged to store information relating to usage of recipes for release to authorized persons so that the paint manufacturer can obtain statistical evidence of shade usage.

Preferably the substrate of the paint chip is arranged to receive the component within the thickness of the substrate so as to avoid a stack of the chips becoming unbalanced due to differential thicknesses. This can be achieved by the component being received within a hole or recess of the substrate.

Preferably the component on the can is connected to a pair of conductors for contact with sensing conductors at the paint tinting station. These conductors can be arranged around a peripheral wall of the can or the component and the pair of conductors can be arranged on the base.

Preferably the paint tinting station has an input for entering a further characteristic of the paint such as a finish, flat, gloss or eggshell for example or a quality, or price point, of the paint. The input can be a reader for a code on a second substrate to be input at the paint tinting station. The processor of the paint tinting station can be arranged to enable dispensing only if the code on the can confirms that the can matches the further required characteristic of the paint.

Preferably the processor of the paint tinting station is arranged to retain in a memory the recipe for the required shade as dispensed into a can in association with the code on the can and is arranged, on return of the can to the reader, to withdraw from the memory the recipe for dispensing the same recipe into a new can. Scaling or adjustment may be made to the recipe to accommodate different sized can or different type of paint, as required by the customer.

Preferably there is provided at the paint tinting station an over-ride switch for over-riding the dispensing of the recipe and an input for entering manually a selected recipe. The over-ride switch can be operable in the event that the processor is unable to locate the recipe or it can be operable in the event that an operator wishes to use an alternative recipe. In either case, the processor of the paint tinting station can be arranged to retain in a memory the manually entered recipe in association with the code on the can.

In one option, the processor of the paint tinting station can be arranged to transmit to a remote processor the code on the can and to receive from the remote processor confirmation that the code is authentic and has not been used previously and to only allow the dispensing of the recipe on receipt of the confirmation. This can be used for real time authentication of cans to prevent supplier brand substitution or counterfeiting. Alternatively, subsequent analysis can be used to later detect brand substitution or counterfeiting by the processor of the paint tinting station being arranged to transmit to a remote processor the code on the can and the remote processor is arranged to analyze code of cans used at a particular location to identify use of cans where the code is not authentic or is a duplicate of a previously used code to identify locations where the act of brand substitution or counterfeit cans are being used.

Preferably there is provided a device at the paint chip display stand for reading the components on the paint chips to provide an indication of the number of paint chips remaining at the paint chip display stand for re-stocking.

In one option, the processor of the paint chip display stand can be arranged to transmit to a remote processor the quantities and/or codes on the paint chips to allow tracking of usage by location and to track the need for replenishment, restocking and/or rearrangement of chips.

It is also an aspect of the present invention, separate from the invention defined above, that there is provided an apparatus for use in dispensing tinted paint comprising:

a plurality of sets of paint chips, each having applied thereto at least one paint sample of a selected shade;

a paint chip display stand having a plurality of receptacles each for receiving a selected one of the sets so that the sets can be displayed to a potential purchaser for selection by the purchaser of a selected one of the paint chips carrying a desired paint shade;

each paint chip having applied thereto a component defining a readable code;

wherein there is provided a device at the paint chip display stand for reading the components on the paint chips.

It is also an aspect of the present invention, separate from the invention defined above, that there is provided an apparatus for use in dispensing tinted paint comprising:

a plurality of sets of paint chips, each having applied thereto at least one paint sample of a selected shade;

each paint chip having applied thereto an RFID defining a readable code.

It is also an aspect of the present invention, separate from the invention defined above, that there is provided an apparatus for use in dispensing tinted paint for use with cans of paint base each having thereon a component defining a readable code, the apparatus comprising

a paint tinting station;

the paint tinting station having a location for receiving a selected one of the cans of paint base;

the paint tinting station having a reader for reading the code on the selected one of the cans of paint base;

the paint tinting station having a dispenser of colorants for mixing with the paint base in the selected can to formulate a required shade;

the paint tinting station having a processor for controlling the dispenser in accordance with a pre-determined recipe for the required shade;

at least one memory;

the memory containing a data base of shades and the recipes therefor;

the memory containing data for determining from the code read from the can an authentication of the can as an acceptable can.

the processor being arranged to operate the dispenser to dispense into a selected can a recipe of colorants after reading the code on the can to determine the authenticity of the can.

It is also an aspect of the present invention, separate from the invention defined above, that there is provided an apparatus for use with a plurality of sets of paint chips, each paint chip having applied thereto at least one paint sample of a selected shade and each paint chip having applied thereto a component defining a readable code in dispensing tinted paint, the apparatus comprising:

a paint tinting station;

the paint tinting station having a reader for reading the code on a selected one of the paint chips;

the paint tinting station having a dispenser of colorants for mixing with the paint base in the selected can to formulate a required shade;

the paint tinting station having a processor for controlling the dispenser in accordance with a pre-determined recipe for the required shade, the processor being arranged to receive data from the codes on the paint chips when read;

at least one memory containing a data base of shades and the recipes therefor;

the processor being arranged to operate the dispenser to dispense into a selected can a recipe of colorants after reading the code on the paint chip and after determining from the memory the pre-determined recipe for the code on the paint chip.

### BRIEF DESCRIPTION OF THE DRAWINGS

One embodiment of the invention will now be described in conjunction with the accompanying drawings in which:

FIG. 1 is a schematic illustration of an apparatus for dispensing tinted paint.

FIG. 2 is a schematic isometric illustration of the paint chip display stand of FIG. 1.

FIG. 3 is a front elevational view of a paint chip of FIG. 1.

FIG. 4 is a front elevational view of an alternative paint chip of FIG. 1.

FIG. 5 is a cross sectional view of the paint chip of FIG. 4 taken along the lines 5-5.

FIG. 6 is a cross sectional view of the paint chip of FIG. 4 taken along the lines 6-6.

FIG. 7 is a cross sectional view of an alternative arrangement of the paint chip display stand of FIG. 1 using the chips of FIGS. 4, 5 and 6.

FIG. 8 is an isometric view of the paint can and reader of FIG. 1.

FIG. 9 is a bottom plan view of an alternative arrangement of the paint can of FIG. 1.

In the drawings like characters of reference indicate corresponding parts in the different figures.

### DETAILED DESCRIPTION

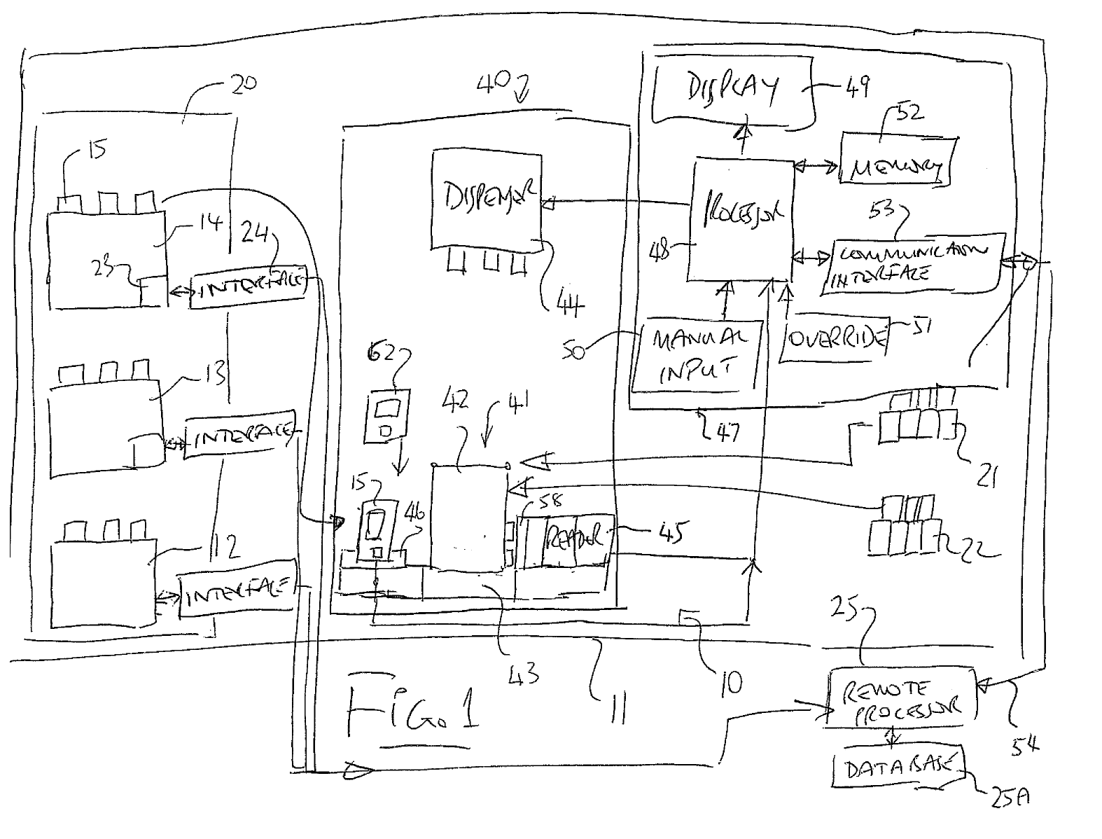

In FIG. 1 is shown a schematic illustration of a paint dispensing apparatus 10 which is intended to be used in a retail location 11 for dispensing tinted paint to customers. The customers may be individual home owners or trade persons as required.

At the retail location is provided a first area 20 where the customers can view individual paint chips for assessing a preferred color for that customer. It will be appreciated that an important part of selling paint is in the colors including carefully designed and crafted shades of color which can be selected by the customer. These shades and their location in the display can vary over time as fashions change so that new colors are added to the available list of colors and others deleted and others moved about in the display.

Yet other colors may be changed slightly in the recipe for forming those colors as formulations of the paint change.

It will be appreciated in general that at the retail location is provided a series of paint cans 21 and 22 which contain particular base paints for mixing with a selected recipe of colorants to generate the shade required by the customer. The paint bases 21 and 22 can come in a number of different paint characteristics including particularly the finish of the paint which can be gloss, matte or other finish characteristics well known in the paint industry. Yet further the paint cans may contain paints of different quality or price levels which have different formulations for different characteristics. Thus paints may be manufactured for external use or internal use or use in humid environments and so forth. Further recent developments in paint manufacture have modified the formulation for the purposes of reducing emissions and improving the safety of paint.

The various supplies of paint cans therefore will contain these different types of paint for mixing with the different colorants.

It is well known that paint chips are manufactured containing one or more colored patches or chips which the customer takes as a free sample for the customer to make an analysis as to the required color to be used. Even though the paint chips have a cost and represent significant investment in the creation of the color shade, the paint supplier commonly gives away the paint chips without cost in the expectation and hope that the customer will return with the paint chip and purchase the corresponding brand of paint in the required color from the supply of paint in the cans 21 and 22 after mixing with the required colorants.

Thus in the first area 20, the display of the paint chips is presented to the customer in an array of racks schematically indicated at 12, 13 and 14 each containing a plurality of paint chips 15.

Many of the paint chips carry a single color which in effect covers substantially all or all of one face of the chip. Other paint chips can contain more than one color patch. Recently the single color chips have become more desirable in order that the customer can take the paint chip to the location where the paint will be installed in order to see the effect of the color in the specific location.

The paint chips are therefore stored in racks with the intention that the rack has a number of locations where a series of paint chips are stored where each paint chip is of the same color so that the customer may take a first chip from the supply leaving a plurality of existing paint chips in the rack for the next customer.

It is highly desirable therefore to maintain an effective and complete supply of the paint chips so that the customer is properly served by being able to select from the full supply rather than have missing paint chips which may lead to the customer departing with no selection made or selecting from another brand or supplier or store.

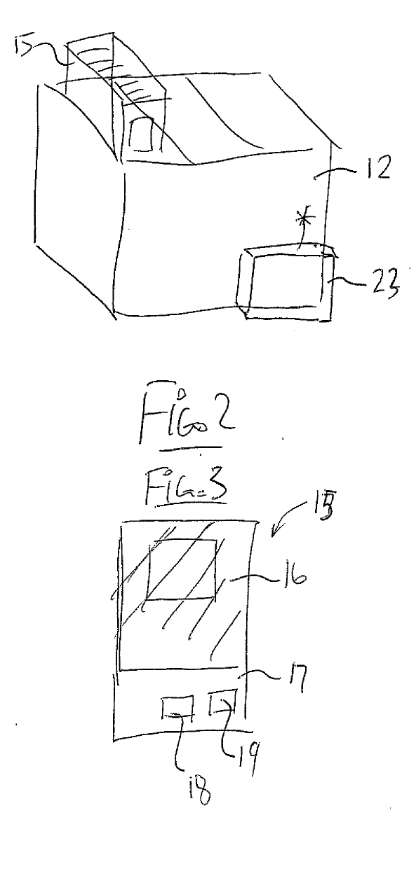

In the present arrangement a paint chip is indicated in FIG. 3 and contains a colored area 16 on a substrate 17. Also on the substrate is provided an element 19 providing a code which may or may not be unique to the individual paint chip. The code is contained on a data base in association with information defining the color on the chip. Further information 18 may also be printed on the paint chip concerning the manufacturer and any other information that is required.

The code can be stored on the paint chip in many different techniques.

One simple technique is the application of a 2D bar code. More complex bar codes which are called “3D” bar codes can also be used. Such bar codes include the arrangement of markings which make up a bar code together with colors which add a further possibility to the code to be read thus providing further numbers of characters which can be stored.

The term bar code has become established as a term for machine readable codes where the code is printed into an area with various markings in various patterns in accordance with a protocol determined by the manufacturer and designer of the system. The codes do not necessarily need to have “bars” and any type of pattern can be used which is readable by a machine operated system. Commonly the reading is carried out by a laser scanner but this is not essential to the system.

While the bar code system can be used in the present invention, this is not the preferred arrangement since the bar code with sufficient characters could be slow and difficult to print and has the potential for reading errors which would lead to undesirable production of mis-tinted cans of paint which become scrap.

The preferred arrangement of the present invention utilizes an electronic circuit applied onto the substrate 17. The electronic circuit is preferably one which provides merely a code since the requirement is preferably that the electronic circuit merely identified the particular chip which has been selected by the customer. The code is unique to each chip as opposed to each color. It will be appreciated that the chips are manufactured in many millions as they are give away items and hence it is necessary to have a relatively large number of characters to ensure that each paint chip has an individual unique code.

As an alternative, the electronic circuit may be one which has other functions than merely the provision of a code. However in the present description, the only requirement is that the electronic circuit provide a readable code.

The code can be read by any one of a different number of techniques. In one technique the code can be read by a RF signal transmitted from a reader 23 on the individual rack 14 containing the chips 15. Thus the reader 23 can emit a polling signal on a periodic basis to obtain data transmitted from the individual paint chips stored within the rack.

Protocols are necessary to manage the data from the various paint chips, bearing in mind that there will be significant number of collisions of data which need to be resolved. However the information requirement for the paint chips in the rack is relatively slow and hence protocols can be used which acquire the information on a relatively slow basis thus allowing the collisions to be dealt with using conventional data transmission protocols.

The reader 23 therefore acquires from all of the chips stored in the rack 12 the individual codes for those chips. In this way the reader 23 can determine the number of chips in the rack for purposes of detecting the removal of the chips and the requirement for replacement of removed chips. It will be appreciated that the number of chips removed may vary dramatically between the colors so that the reader 23 will obtain information both to restocking of the chips and also information relating to preferences of the chips as selected by the customer.

The reader 23 can be arranged to transmit through an interface 24 to a remote processor 25 using conventional communication techniques. Thus the information from the reader 23 can be transmitted to the processor to instruct a person which may be a clerk within the retail location or may be a person employed by the paint supplier to effect restocking to ensure that all of the racks are properly stocked with the number of paint chips required.

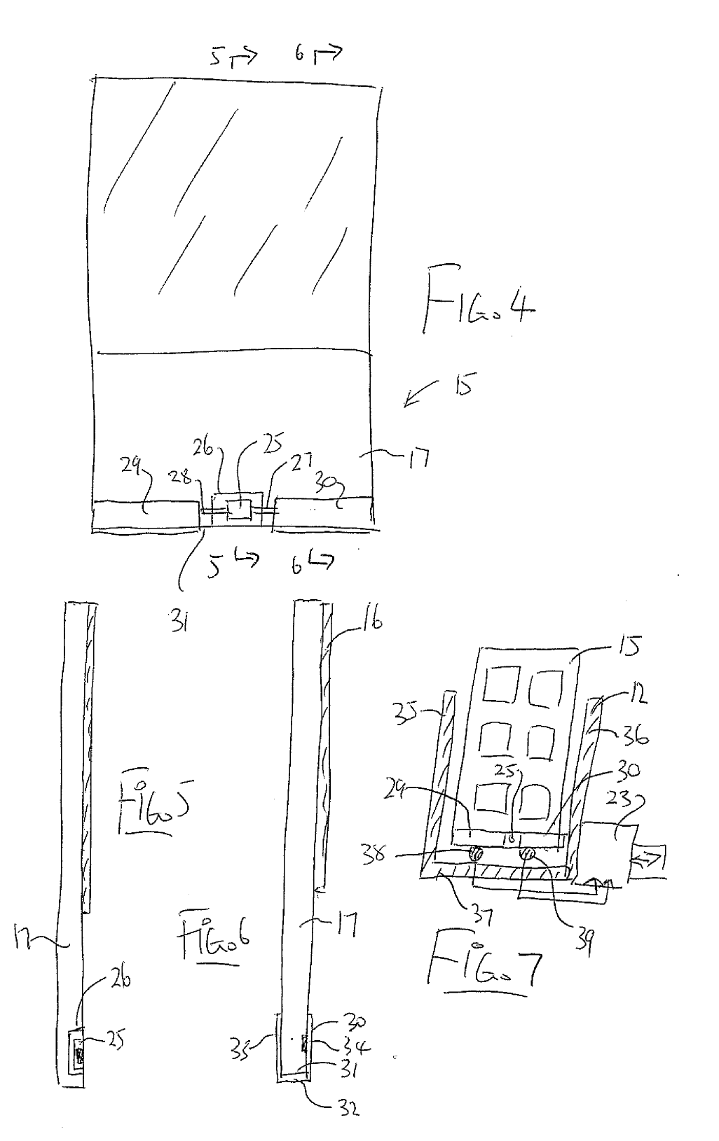

In FIG. 2, the communication between the paint chip and the reader is effected by an RF transmission. Other techniques of reading can also be used. One particularly preferred arrangement for reading of the code is shown in FIGS. 4 through 7. Thus the paint chip 15 shown in FIGS. 4, 5 and 6 includes the substrate 17 on which the colorant layer 16 is applied. In this embodiment there is provided an electronic circuit 25 which is mounted on the substrate 17. In order that the circuit 25 does not increase the thickness of the substrate 17, a recess or indented portion 26 is provided in the substrate to receive the thickness of the circuit 25 attached onto the substrate within the recess 26 by a suitable technique such as adhesive. In the event that an indent or recess is insufficient to receive the thickness of the circuit 25, a hole may be punched through the substrate. In further arrangements, the circuit 25 may instead be simply formed on the substrate by printing directly ink or ink-like layers on the substrate with substantially no increase in thickness in the substrate. Techniques for directly printing circuits are becoming available and such a technique may be used in this circumstance.

The circuit 25 has a pair of conductors 27 and 28 which connect to a pair of conductive terminals 29 and 30 printed onto the substrate 17. Again these terminals are printed on a manner which avoids any significant increase in the thickness of the substrate. These terminals can be printed from carbon based ink so that they provide sufficient conductivity to allow connection through the terminals to suitable edge contactors engaging the edge of the substrate. Thus it will be noted that the terminals 29 and 30 are printed at the bottom edge 31 of the substrate and are printed so that the terminals cover the bottom edge 31 to provide an edge layer 32 together with front and back surface layers 33 and 34. Thus contact can be made with the terminals 29 and 30 either by contacting the front or rear surface of the substrate at or adjacent the bottom edge or by directly contacting the bottom edge of the substrate. The terminals 29 and 30 are located apart on the bottom edge of the substrate leaving an area at the circuit 25 which is open to maintain electrical separation between the terminals 29 and 30.

As shown in FIG. 7, the paint chip 15 is located in the rack 12. The rack 12 has upstanding side walls 35 and 36 which confine the paint chip so that the paint chips are arranged in a row along the rack between the side walls 35 and 36. The rack further has a bottom wall 37 which supports the paint chips in the row. Just above the bottom wall 37 is provided a pair of conductive rails 38 and 39 as suitable spacing to respectively engage the contacts 29 and 30. Thus each paint chip and the circuit 25 thereon can communicate with the rails and through the rails to the reader 23. In the embodiment of FIG. 7, the communication between the circuit 25 and the reader 23 is effected by direct electrical contact allowing the reader to pull the circuits 25 of the chips that are in place on the rack. The use of direct contact has the advantages that it may reduce the number of data collisions. More accurate data communication therefore may occur allowing an increase in data transmission rates. In addition the avoidance of the use of radio frequency transmissions avoids the necessity for managing such radio frequency transmissions within required frequency bands. The edge contact reading system is therefore preferred although the radio frequency reading system maybe used in some circumstances. In addition devices are available which are both contact readable and readable by RF transmissions and in some cases such devices may be used.

In the same retail location 11 is provided a paint dispensing apparatus generally indicated at 40 which is arranged to receive the paint cans from the supply 21, 22 so that each paint can when selected at a can receptacle location 41 where the can 42 sits on a support 43. The can is located underneath a colorant dispensing head 44 so that selected colorants can be dispensed into the can when opened while sitting at the receiving station 43.

The dispensing apparatus further comprises a can reader 45 and a chip reader 46. The apparatus further comprises an electronic communication section 47. The electronic communication section 47 comprises a processor 48 which receives inputs from the reader 46 and 45 at an output for controlling the dispenser 44. The electronic dispenser 44 further includes a display 49 for displaying to a user information generated by the processor. The section further includes a manual input or keyboard 50 together with an override switch 51. The section further includes a memory 52 for providing a database and providing program information for the processor 48. The section further includes a communication interface 53 for communication through a suitable communication route 54 with the remote processor 25. The remote processor 25 includes a data base 25A.

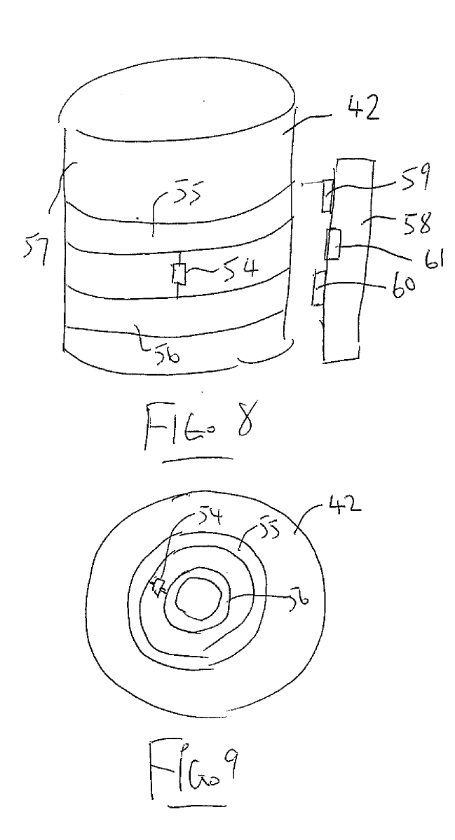

Each of the cans 42 as best shown in FIGS. 8 and 9 includes a code generating member 54 defined in this embodiment by an electronic circuit of the type previously described. The circuit 54 communicates with a pair of conductors 55 and 56 provided on the can. In the embodiment of FIG. 8, the circuit component 54 is located on the peripheral wall 57 of the can and the conductors 55 and 56 are wrapped around a portion of the peripheral wall. In a preferred arrangement shown in FIG. 9, the circuit component 54 and the conductors 55 and 56 are located on the base of the can and preferably these are provided as concentric circles on the base with the circular element 54 located between the concentric circles.

The reader 45 includes a can engaging portion 58 which includes two contacts 59 and 60 for engaging respectively the conductors 55 and 56. A magnet 61 can also be provided to pull the can into position against the can engaging member 58. In the embodiment shown in FIG. 8, the can engaging member stands up along side the can at the reader 45. In the embodiment of FIG. 9, the can engaging member will form a base onto which the can is placed.

The electronic component 54 can comprise an element known as a “Dallas 1-wire” component manufactured and sold by Dallas Semi Conductor Corp. Devices supplied by this company are typically mounted in a button or container but other arrangements can be provided in which the circuit itself is provided as a stand alone item for low cost. The device therefore provides one of the conductors 55 and 56 as a ground and the other of the conductors as a power and communication bus. The device can therefore be simply applied to the can and connected by external wires to the conductors 55 and 56. In use the customer having selected the particular paint chip to provide the color required, carries that paint chip to the dispensing station 40. At this dispensing station, the paint chip 15 is inserted into the reader 46 which acts to extract the unique code which is then communicated to the processor 48.

In some embodiments it is also possible that further cards indicated at 62 are inserted into the reader 46. These cards 62 can include one or more additional characteristics of the paint to be selected. Thus for example the card 62 may carry a particular type of paint finish so that the customer can see exactly the type of finish to be obtained with the paint concerned. On the same card or on additional cards, paint type or quality might be selected thus different types of paint for exterior finish, interior finish or other types of material can be selected using this technique. Yet further the supplier may provide different qualities of paint to be selected at different price points and again this can be entered using a selection card 62.

As an alternative to the use of selection cards, the manual input 50 may be used to enter the required finish, paint type and paint quality or other characteristics of the paint.

With this information entered into the processor, the processor accesses from the memory 52 or from the data base 25A information relating to the can to be selected together with the recipe for the colorants to be injected. The information concerning the can may be displayed on the display 49 to allow the customer or a store person to select from the various supplies 21, 22. A selected can is applied onto the support 43 at the reader 45. The reader 45 then accesses the code on the can 42 and uses that code to determine whether the can in place on the base 43 is the proper can for receiving the colorant.

Thus the processor can determine whether the can is selected of the right characteristics as input by the customer. In addition the processor can determine that the can is of the type manufactured by the manufacturer managing and controlling the paint dispensing system.

The processor can therefore be arranged so that the dispenser will only operate in the event that all of the parameters of the paint properly satisfy the requirement. In the event that one or more of the characteristics is improper, this information can be displayed on the display 49 to inform the customer and/or the store person that the paint can selected is improper for the reason determined.

In the event that there is a failure in communication so that the system cannot determine from the remote data base the required information to determine the characteristics of the can, an override switch 51 can be operated either automatically or by the person operating the machine so that the dispenser can carry out a dispensing action and override the determination by the processor that the can is improper or override the failure of the processor to act. In this way the device can be operated even in the event of a power failure or a communication failure. Dispensing is therefore not held up in this event.

Yet further the manual override switch 51 can be operated in the event that the customer and/or store person wishes to dispense a recipe independent of the paint chips and the stored recipes. Thus if the override switch 51 is operated in situation, the person operating the machine can activate the dispenser independently of the processor to dispense a recipe selected by the person.

When a dispensing action is carried out either at the control of the processor or at the control of the person operating the device, the processor acts to store in memory 52, information identifying the particular unique identifying code of the can in association with the recipe actually dispensed. This information is retained locally in the memory 52. This information allows a customer to return to the location 11 with a can and to a place that can at the reader 45 or at a separate reader independent of the reader 45 to extract from the returned can the unique code. This unique code can then be used to extract from the memory 52 the characteristics of the paint and the recipe for the colorant so that exactly the same paint can be remixed in a fresh can selected from the supplies 21 and 22 using the same recipe. The recipe may be adjusted to accommodate a different size of can or quantity of paint or type of base or type of finish.

The display 49 can be used to display information concerning the paint to be dispensed to the person operating the machine before the dispensing action is carried out to provide a manual check of the operation. This can be used to avoid wrong information being used for example by a communication error or by selection of an incorrect paint insert card or paint chip and allows a final check of the system to be carried out. In the event that a paint chip carries multiple colors, the display can be used to display the color selected or allow the user to select from a display of the colors on the multiple paint chip card, allowing the person operating the machine to select the required color using for example a touch screen or simply using a conventional mouse or keyboard system.

The management of the data between the memory 52 and a remote data base 25A can be controlled in many different ways, bearing in mind that the amount of data can be extensive for all of the individual paint chips and all of the individual paint cans

For example, therefore, the memory 52 at the store location may be used to store recipes for the paint chips supplied to that particular location. In the event that a person comes to the store carrying a paint chip from the remote location or carrying a paint chip from an older time, this information may not be available at the memory 52 requiring the system to communicate with the remote data base 25A. The remote data base 25A may be a central date base at the manufacturing location or maybe a smart cache at individual locations.

The memory 52 may be used to store information concerning all properly authentic cans to be used in the dispensing machine. This information may be entered during supply of the cans to the location. The processor may be arranged to delete from the list of authentic cans a particular can when that can has already been used.

It will be appreciated that the intention is that the system be used to ensure as far as possible that only authentic cans supplied by the manufacturer managing the system. One way to control this therefore is to cause the system to prevent the use of a can which does not carry a code which is properly authenticated by the data base as an acceptable proper can of paint which has not previously been used.

However in view of the large numbers of products involved, a real-time control of this system to prevent dispensing may not be practical depending upon the size of the manufacturer and the inventory control systems used.

As an alternative, therefore, the system may be utilized to record the dispensing operations and the unique codes of the cans used. This information can then be analyzed at a later date in order to determine whether there is wide scale use of substitute brand or counterfeit cans.

As the manufacturer of the paint only obtains revenue from the sale of the paint in the cans, there are significant commercial pressures for counterfeiting to be utilized and that the system can therefore be used by the manufacturer to deter such counterfeiting and to determine locations where such counterfeiting is occurring on a small or large scale. It will be appreciated that a determined counterfeiter can generate cans of paint which carry a substantially identical code even though of course those codes will not be authenticated by the system. The reader and the processor therefore may act to utilize such cans in a dispensing action since they carry a code even though that code is not a proper code. However this counterfeiting will be determined by a subsequent analysis of the system.

Another technique for maintaining the sale of the paint within the hands of the particular manufacturer, bearing in mind the considerable expense and investment in the paint chips and the colors used, is to ensure that the recipe remains secret. Thus the details of the recipe may not be available at the display or otherwise to the user of the machine and can be communicated from the processor directly to the dispenser without any outside indication as to the actual recipe dispensed. In this way, the user of the machine cannot simply obtain the recipe and take it to another location where the control systems are not used and utilize the same recipe on the paint of another supplier.

The release of information concerning dispensing actions carried out can be released to a user of the machine at the display 49 when properly authorized or may be communicated to the remote processor 25 for access only at that remote location. In any event the information concerning the trend in selections for further design and information relating to the possible counterfeiting are all available to authorized persons for extraction as required.

The system can also be used for dispensing materials other than paint. It maybe possible to use the system for dispensing carpet, wood grain materials, tile and upholstery samples.

It is also possible that the recipe for a particular color of paint be encoded in the circuit coded onto the chip itself. In this way the recipe is always available even in the event of failure of communication or in the event that the chip is no longer current in the supply system of the manufacturer.

However this storage of the data for the recipe on the paint chip itself does not allow the system to change the recipe. It will be appreciated that the changing of recipes may be necessary as paint development continues on an ongoing basis. Thus components within the paint may be changed and may require a slight change in the recipe. This can only be accommodated if the recipe is stored in the memory of the system and thus can be modified on the system rather than on the paint chips.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for use in dispensing tinted paint comprising:
a plurality of sets of paint chips, each comprising a substrate and having applied thereto at least one paint sample of a selected shade;
a paint chip display stand having a plurality of receptacles each for receiving a selected one of the sets so that the sets can be displayed to a potential purchaser for selection by the purchaser of a selected one of the paint chips carrying a desired paint shade;
each paint chip having applied thereto a component defining a readable code;
a plurality of cans of paint base;
each can of paint base having thereon a component defining a readable code;
a paint tinting station;
the paint tinting station having a location for receiving a selected one of the cans of paint base;
the paint tinting station having a reader for reading the code on the selected one of the cans of paint base;
the paint tinting station having a reader for reading the code on the selected one of the paint chips;
the paint tinting station having a dispenser of colorants for mixing with the paint base in the selected can to formulate a required shade;
the paint tinting station having a processor for controlling the dispenser in accordance with a pre-determined recipe for the required shade, the processor being arranged to receive data from the codes on the paint chips when read and the codes on the cans when read;
the processor being arranged to obtain the recipe using the data received;
the processor being arranged to operate the dispenser to dispense into a selected can a recipe of colorants after reading the code on the paint chip, after determining the pre-determined recipe and after reading the code on the can.

2. The apparatus according to claim 1 wherein the component on the paint chip is an electronic device readable by RF transmission.

3. The apparatus according to claim 1 wherein the component on the chip is an electronic device with conductors on the chip readable by contact with a conductive sensor.

4. The apparatus according to claim 3 wherein the conductors are formed from a conductive ink including a part of the ink located on the edge of the substrate.

5. The apparatus according to claim 3 wherein the conductors are formed from a conductive ink including a part of the ink located on the face of the substrate.

6. The apparatus according to claim 1 wherein the component on the paint chip is a bar code.

7. The apparatus according to claim 1 wherein at least some of the paint chips have thereon multiple colors, where each paint chip is associated with one readable code.

8. The apparatus according to claim 1 wherein the paint tinting station includes a display for showing to an indication of the color selected.

9. The apparatus according to claim 1 wherein the paint tinting station includes a display for showing to a customer an indication of the eligible colors and wherein at least some of the paint chips have thereon multiple colors so that the customer can select one of the indicated colors at the display.

10. The apparatus according to claim 1 wherein the recipe is arranged to be retrieved from a data base of recipes associated with the paint chip codes.

11. The apparatus according to claim 1 wherein the paint tinting station includes a connection for electronic communication with a remote station for retrieving other recipes.

12. The apparatus according to claim 10 wherein the paint tinting station includes in a memory of the paint tinting station recipes of color chips contained in paint chip display stands at the same location.

13. The apparatus according to claim 11 wherein the paint tinting station includes a connection for electronic communication with a remote smart cache of recipes.

14. The apparatus according to claim 1 wherein the paint tinting station is arranged to access a list of authentic cans for determining, from the code read from the can, an authentication of the can.

15. The apparatus according to claim 1 wherein the memory and the processor of the paint tinting station are arranged to keep the recipes secret so that dispensing is carried out automatically without providing information to the customer or a store clerk.

16. The apparatus according to claim 1 wherein the memory and the processor of the paint tinting station are arranged to store information relating to usage of recipes for release to authorized persons.

17. The apparatus according to claim 1 wherein the substrate is arranged to receive the component within the thickness of the substrate.

18. The apparatus according to claim 16 wherein the component is received within a hole or recess of the substrate.

19. The apparatus according to claim 1 wherein the component on the can is connected to a pair of conductors for contact with sensing conductors at the paint tinting station.

20. The apparatus according to claim 19 wherein the pair of conductors are arranged around a peripheral wall of the can.

21. The apparatus according to claim 19 wherein the component and the pair of conductors are arranged on the base.

22. The apparatus according to claim 1 wherein the paint tinting station has an input for entering a further characteristic of the paint.

23. The apparatus according to claim 22 wherein the further characteristic is a finish or a quality of the paint.

24. The apparatus according to claim 22 wherein the input is a reader for a code on a second substrate to be input at the paint tinting station.

25. The apparatus according to claim 22 wherein the processor of the paint tinting station is arranged to enable dispensing only if the code on the can confirms that the can matches the further characteristic of the paint.

26. The apparatus according to claim 1 wherein the processor of the paint tinting station is arranged to retain in a memory the recipe for the required shade as dispensed into a can in association with the code on the can and is arranged, on return of the can to the reader, to withdraw from the memory the recipe for dispensing the same recipe into a new can.

27. The apparatus according to claim 1 wherein there is provided at the paint tinting station an over-ride switch for over-riding the dispensing of the recipe and an input for entering manually a selected recipe.

28. The apparatus according to claim 27 wherein the over-ride switch is operable in the event that the processor is unable to locate the recipe.

29. The apparatus according to claim 27 wherein the over-ride switch is operable in the event that an operator wishes to use an alternative recipe.

30. The apparatus according to claim 27 wherein the processor of the paint tinting station is arranged to retain in a memory the manually entered recipe in association with the code on the can.

31. The apparatus according to claim 1 wherein the processor of the paint tinting station is arranged to transmit to a remote processor the code on the can and to receive from the remote processor confirmation that the code is authentic and has not been used previously and to only allow the dispensing of the recipe on receipt of the confirmation.

32. The apparatus according to claim 1 wherein the processor of the paint tinting station is arranged to transmit to a remote processor the code on the can and wherein the remote processor is arranged to analyze code of cans used at a particular location to identify use of cans where the code is not authentic or is a duplicate of a previously used code to identify locations where counterfeit cans are being used.

33. The apparatus according to claim 1 wherein there is provided a device at the paint chip display stand for reading the components on the paint chips to provide an indication of the number of paint chips remaining at the paint chip display stand for re-stocking.
